(19) United States
(12) Patent Application Publication
(10) Pub. No.: US 2010/0195018 A1
(43) Pub. Date: Aug. 5, 2010

(54) COUPLING STRUCTURE BETWEEN BACKLIGHT AND INVERTER OF LIQUID CRYSTAL DISPLAY

(76) Inventor: Woo Il Kim, Gyeongsangnam-do (KR)

Correspondence Address: Jeff Lloyd;Saliwanchik, Lloyd & Saliwanchik, A Professional Association, PO Box 142950, Gainesville, FL, 32614-2950, US

(21) Appl. No.: 12/421,100

(22) Filed: Apr. 9, 2009

(30) Foreign Application Priority Data
Apr. 15, 2008 (KR) 10-2008-0034692

(51) Int. Cl. G02F 1/1333

(52) U.S. Cl. 349/60

(57) ABSTRACT

The present invention relates to a coupling structure between a backlight and an inverter of a liquid crystal display device, and more specifically to a coupling structure between a backlight and an inverter of a liquid crystal display in which assembly between an inverter and a backlight is simplified to improve workability as well as wiring is not exposed to be clean in appearance.

To this end, there is provided a coupling structure between a backlight and an inverter of a liquid crystal display, the backlight having a light emitting lamp including a power supply terminal installed therein and the inverter applying power to the backlight characterized in that one side on a rear of the backlight is formed with a plurality of inserting holes communicating with an inside of the backlight, the inserting hole is installed with a conductive rubber connected to the power supply terminal of the light emitting lamp, the center of the conductive rubber being formed with a conducting hole, and the inverter is installed with a tap protruded toward the conducting hole of the conductive rubber, the tap being inserted in the conducting hole to conduct the light emitting lamp.

### CROSS-REFERENCE TO RELATED APPLICATION

The present application claims the benefit under 35 U.S.C. §119 of Korean Patent Application No. 10-2008-0034692, filed Apr. 15, 2008, which is hereby incorporated by reference in its entirety.

### BACKGROUND OF THE INVENTION

1. Field of the Invention

The present invention relates to a coupling structure between a backlight and an inverter of a liquid crystal display device, and more specifically to a liquid crystal display in which a coupling structure between an inverter and a backlight is simplified, thereby reducing efforts and improving productivity.

2. Description of the Related Art

Recently, studies on a flat panel display device have actively been progressed. Among others, studies on a liquid crystal display, a Field Emission Display Device (FED), an Electro-luminescene Display Device (ELD), a Plasma Display Pannels (PDP), etc., have actively been progressed.

Among them, the LCD (hereinafter, referred to as liquid crystal display') is mainly used instead of a Cathode Ray Tube (CRT) as a mobile image display because of advantages such as superior picture quality, light weight, slimness, low power consumption. In addition to the mobile image display such as a monitor for a notebook computer, it has variously been developed as a television receiving and displaying a broadcasting signal, a monitor for a computer, etc.

Although such a liquid crystal display has variously technically been developed in order to serve as a display in various fields, there are many aspects opposite to the above advantages in work for improving picture quality of the display.

Accordingly, in order to allow the liquid crystal display to be used in various fields as a general display, how high quality image such as high definition, high brightness, large area, etc., may be implemented while maintaining features such as light weight, slimness, low power consumption is key point of the development of the present technique.

Such a liquid crystal display may be constituted by a liquid crystal display panel for displaying an image and a driver for applying driving signals to the liquid crystal display panel, wherein the liquid crystal display panel is constituted by first and second substrates forming space and bonded to each other and a liquid crystal layer injected between the first and second substrates.

Meanwhile, since such a liquid crystal display itself is non-emissive, it requires a separate external light source for irradiating light.

In particular, in the case of a transmissive liquid crystal display, a separate dimmer, i.e. a backlight unit, radiating and guiding the light to a rear of the liquid crystal display panel is necessarily required.

Hereinafter, a backlight unit according to the prior art will be described with reference to FIGS. 1 and 2.

The backlight unit is constituted by a plurality of light emitting lamps 1, a case 2 receiving the light emitting lamps 1, light scattering means 4 disposed between the light emitting lamp 1 and a liquid crystal panel 3, and a bezel portion 5 surrounding the edge of the liquid crystal panel except for an effective area on which an image is displayed, as shown in FIG. 1.

At this time, the light emitting lamp 1 is configured of a Cold Cathode Fluorescent Lamp (CCTL) and has electrodes disposed on both ends inside a cathode so that when power is applied to the electrodes, the light emitting lamp 1 is emitted.

At this time, power supply cables 1a for driving the lamp are connected to the electrodes of the light emitting lamp 1, and are connected to separate connectors 1b to be connected to an inverter 4, wherein each light emitting lamp 1 is installed with separate connectors 1b.

That is, in the backlight unit, the plurality connectors 1b are connected to the inverter 4 disposed on a rear of the backlight in order to enable the power to be applied to both electrodes of the light emitting lamp 1, as shown in FIG. 2.

However, a coupling structure between the inverter and the backlight of the above-mentioned liquid crystal display has follow problems:

In the backlight, the connectors 1b are connected to the power supply cables 1a of the light emitting lamps 1 to be connected to the inverter 4. Since these connectors 1b are separately required for each of the light emitting lamps 1, wiring is complicated. And, since the plurality of connectors 1b should be separately connected to the inverter 4, work efficiency is lowered.

Also, a structure of an assembly process is complicated to cause badness of a product.

Furthermore, process time increases so that productivity of the product is lowered.

### SUMMARY OF THE INVENTION

The present invention has been proposed in order to solve the above problems. It is an object of the present invention to provide a coupling structure between a backlight and an inverter of an liquid crystal display in which an assembly structure and process of the backlight and the inverter is simplified, thereby reducing badness ratio of a product and improving productivity of the product.

To this end, there is provided a coupling structure between a backlight and an inverter of a liquid crystal display, the backlight having a light emitting lamp including a power supply terminal installed therein and the inverter applying power to the backlight characterized in that one side on a rear of the backlight is formed with a plurality of inserting holes communicating with an inside of the backlight, the inserting hole is installed with a conductive rubber connected to the power supply terminal of the light emitting lamp, the center of the conductive rubber being formed with a conducting hole, and the inverter is installed with a tap protruded toward the conducting hole of the conductive rubber, the tap being inserted in the conducting hole to conduct the light emitting lamp.

At this time, the tap preferably includes a fixing portion fixed to the inverter by soldering and an inserting portion bended vertically from the fixing portion to be inserted in the conducting hole.

At this time, the inserting portion is preferably further formed with a bending portion re-bended from the end of the inserting portion to the outside of the inserting portion toward the fixing portion.

At this time, a connection portion of the inserting portion and the bending portion is preferably rounded.

Also, cross-section of the inserting portion and the bending portion preferably is a ‘U’ shape.

The coupling structure between the backlight and the inverter of the liquid crystal display according to the present invention has following advantages:

One side on the rear of the backlight is formed with the inserting holes communicating with the inside of the backlight, the inserting hole is installed with the conductive rubber including the conducting hole, and the tap of the inverter applying the power to the light emitting lamp is inserted in the conducting hole of the conductive rubber so that the coupling structure between the inverter and the backlight is simplified.

As such, assembly between the backlight and the inverter becomes simple so that badness ratio of a product ie reduced and workabilvity is improved.

Also, as described above, efforts is reduced and the workabivity is improved so that productivity of the product increases.

And, a power supply cable is not exposed to the outside of the backlight so that the coupling structure becomes visually clean.

### BRIEF DESCRIPTION OF THE DRAWINGS

FIG. 1 is an exploded perspective view showing a backlight according to the prior art;

FIG. 2 is a rear view showing a coupling structure between a backlight and an inverter according to the prior art;

FIG. 3 is an exploded perspective view showing a coupling structure between a backlight and an inverter according to a preferable embodiment of the present invention;

FIG. 4 is a perspective view showing a tap of the inverter according to the preferable embodiment of the present invention;

FIG. 5 is a rear view showing a coupled state of the backlight and the inverter according to the preferable embodiment of the present invention; and

FIG. 6 is a cross-sectional view taken along line I-I in FIG. 5.

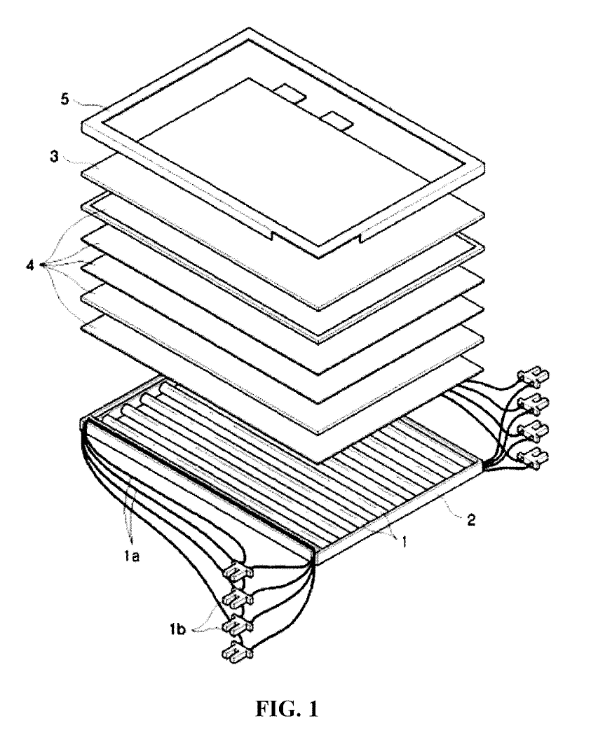

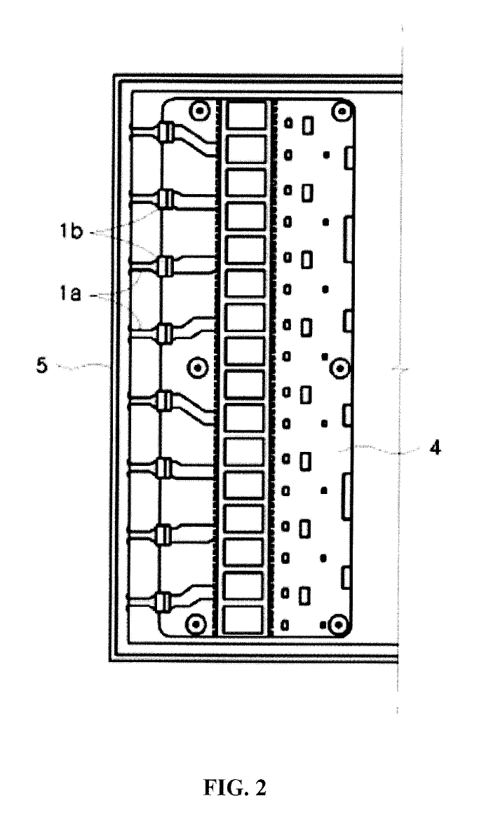

### DESCRIPTION FOR KEY ELEMENTS IN THE DRAWINGS

| | |
|---|---|
| 100: BACKLIGHT | 110: CASE |
| 111: INSERTING HOLE | 112: INSERTING MEMBER |
| 112a: HOLE | 113: CONDUCTIVE RUBBER |
| 113a: CONDUCTING HOLE | 120: LIGHT EMITTING LAMP |
| 121: ELECTRODE | 200: INVERTER |
| 210: TAP | 211: FIXING PORTION |
| 212: INSERTING PORTION | 213; BENDING PORTION |

### DETAILED DESCRIPTION

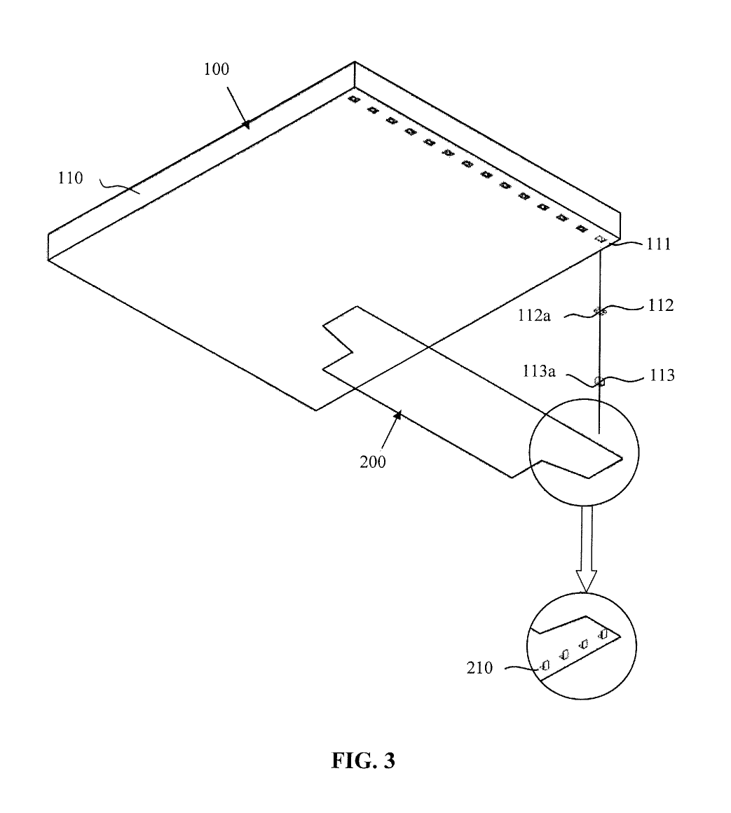

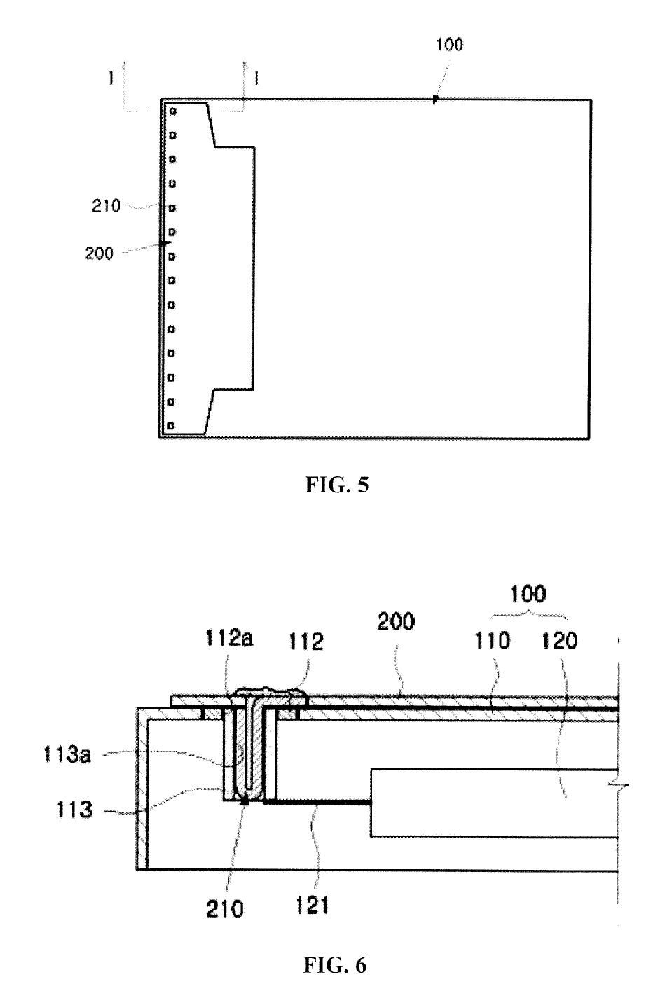

Hereinafter, a coupling structure between a backlight and an inverter of a liquid crystal display according to a preferable embodiment of the present invention will be described with reference to FIGS. 3 to 6.

First, the backlight 100 of the liquid crystal display (hereinafter, referred to as ‘backlight’) radiates light to a rear of a liquid crystal display panel (not shown), and includes a case 110 and a plurality of light emitting lamps 120 installed in the inside of the case 110.

The case 110 preferably has a rectangular shape because a general liquid crystal display has a rectangular shape.

At this time, one side on a rear of the case 110 is formed with a plurality of inserting holes 111 in a row.

Herein, terms ‘a front and a rear of a case’ indicates a surface corresponding to the liquid crystal display panel and a surface opposite to the surface, for convenience of explanation.

Meanwhile, the inserting hole 111 communicates with the inside of the case 110, and is provided in order to enable a conductive rubber described below to be inserted therein.

At this time, the inserting hole 111 preferably has a rectangular shape in order to enable an inserting portion of a tap described below to be smoothly inserted therein.

Also, each of the inserting holes 111 is preferably installed with inserting members 112 made of a plastic material.

This is because the case is usually made of a metal material so that there is a risk of damage of a soft conductive rubber by the metal case 110 when the soft conductive rubber is directly inserted in the inserting hole 111.

The inserting member 112 is formed in a rectangular shape corresponding to the inserting hole 111, and has a hole 112a formed in the center thereof in order to enable the conductive rubber to be inserted therein.

At this time, the hole 112a also preferably has a rectangular shape.

And, the conductive rubber 113 performs a role conducting power of the inverter 200 to the light emitting lamp 120.

As may be seen from a name, the conductive rubber 113 is made of a soft rubber through which current flows.

Also, the conductive rubber 113 is inserted and installed in the hole 112a of the inserting member 112, and is formed in a rectangular shape corresponding to the hole 112a.

And, the center of the conductive rubber 113 is formed with a conducting hole 113a to enable the inserting portion of the tap described below to be inserted therein.

At this time, the conducting hole 113a also preferably has a rectangular shape, and is formed in a similar size to that of the inserting portion of the tap described below.

This is to allow the inserting portion of the tap not to be loosely inserted in the conducting hole 113a.

Next, the inverter 200 applies power to the backlight 100, and is disposed on a rear of the backlight 100.

The inverter 200 is mounted with various circuits for smoothly applying the power to the backlight 100.

And, one side of the inverter 200 is installed with a tap 210 for applying the power to the light emitting lamp 120 of the backlight 100.

The tap 210 is installed in a position corresponding to the conductive rubber 113, but is preferably fixed by soldering.

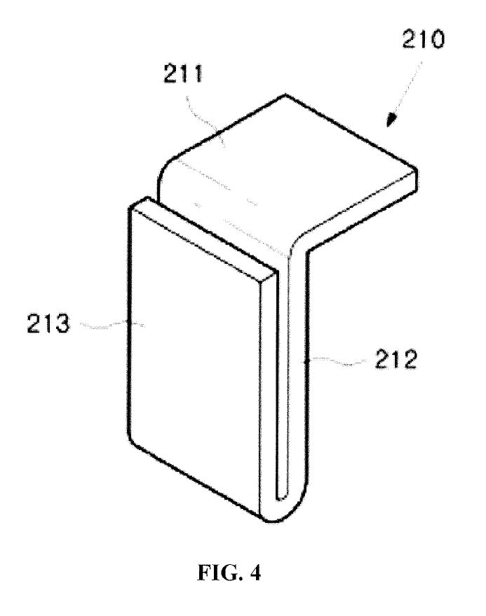

The tap 210 is configured to fit into the conducting hole 113a of the conductive rubber 113, which will be described in detail with reference to FIG. 4.

The tap 210 includes a fixing portion 211 fixed to the inverter 200 by soldering and an inserting portion 212 bended vertically from the fixing portion 211 to be inserted in the conducting hole 113a of the conductive rubber 113.

At this time, the inserting portion 212 is preferably further formed with a bending portion 213 re-bended from the end of the inserting portion to the outside of the inserting portion 212 toward the fixing portion 211.

This is to install the bending portion 213 to have elasticity with respect to the inserting portion 212 so that the bending portion 213 and the inserting portion 212 may more firmly be inserted in the conducting hole 113a of the conductive rubber 113.

At this time, a connection portion of the inserting portion 212 and the bending portion 213, i.e., a portion inserted in the conducting hole 113a of the conductive rubber 113 is formed to be rounded.

That is, a side of the inserting portion 212 and the bending portion 213 is formed similarly to a ‘U’ shape.

Accordingly, the inserting portion 212 and the bending portion 213 have the elasticity as described above, and may be coupled to the soft conductive rubber 113 in a state where an adherent force is further enhanced.

Hereinafter, the coupling between the backlight and the inverter configured as described above will be described.

First, the inserting members 112 are installed in each of the plurality of inserting hole 111 formed on the rear of the case 110.

Thereafter, the conductive rubbers 113 are inserted and installed in each of the holes 112a of the inserting members 112.

At this time, the electrode 121 of the light emitting lamp 120 installed in the inside of the case 110 becomes a state contacted with the conductive rubber 113.

Next, the taps 210 of the inverter 200 are inserted in each of the conducting holes 113a of the conductive rubbers 113.

At this time, the bending portions 213 are inserted in each of the conducting holes 113a of the conductive rubbers 113 while having the elasticity.

Therefore, current applied from the inverter 200 is conducted to the conductive rubber 113 through the tap 210 so that it flows to the light emitting lamp 120 contacted to the conductive rubber 113.

Thereby, the light emitting lamp emits light.

As described above, the inverter 200 is installed with the tap 210 protruded from the inverter 200 and the backlight 100 is installed with the conductive rubber 113 into which the tap 210 fits to receive the power of the inverter 200, so that the coupling structure between the backlight 100 and the inverter 200 is simplified.

As an assembly process becomes simple, workability is improved, resulting in increase of productivity.

Although the coupling structure between the backlight and the inverter of the liquid crystal display according to the embodiment has been described, it is not intended to limit a technical scope of the present invention which is defined only by claims but only to assist understanding of the present invention.

Of course, those skilled in the art may perform various alterations and modifications within the same or equivalent scope.

What is claimed is:

1. A coupling structure between a backlight and an inverter of a liquid crystal display, the backlight having a light emitting lamp including a power supply terminal installed therein and the inverter applying power to the backlight, one side on a rear of the backlight is comprising a plurality of inserting holes communicating with an inside of the backlight, at least one inserting hole installed with a conductive rubber connected to the power supply terminal of the light emitting lamp, the center of the conductive rubber being formed with a conducting hole, and the inverter being installed with a tap protruded toward the conducting hole of the conductive rubber, the tap being inserted in the conducting hole to conduct the light emitting lamp.

2. The coupling structure between the backlight and the inverter of the liquid crystal display according to claim 1, wherein the tap includes a fixing portion fixed to the inverter by soldering and an inserting portion bent vertically from the fixing portion to be inserted in the conducting hole.

3. The coupling structure between the backlight and the inverter of the liquid crystal display according to claim 2, wherein the inserting portion is further formed with a bending portion also bent from the end of the inserting portion to the outside of the inserting portion toward the fixing portion.

4. The coupling structure between the backlight and the inverter of the liquid crystal display according to claim 3, wherein a connection portion of the inserting portion and the bending portion is rounded.

5. The coupling structure between the backlight and the inverter of the liquid crystal display according to claim 3, wherein cross-section of the inserting portion and the bending portion is a ‘U’ shape.

5. The coupling structure between the backlight and the inverter of the liquid crystal display according to claim 4, wherein cross-section of the inserting portion and the bending portion is a ‘U’ shape.
